(19) United States
(12) Patent Application Publication
(10) Pub. No.: US 2001/0023859 A1
(43) Pub. Date: Sep. 27, 2001

(54) Method for the surfae treatment of a tribological coating

(75) Inventors: Markus Beck, Ulm (DE); Tilmann Haug, Uhldingen-Muhlhof (DE); Patrick Izquierdo, Ulm (DE); Michael Lahres, Ulm (DE); Peter Linden, Beimerstetten (DE); Matthias Merkel, Wooster, OH (US); Matthias Merkel, Wooster, OH (US); Harald Pfeffinger, Tiefenbronn (DE)

Correspondence Address: CROWELL & MORING, L.L.P., Suite 700, 1200 G Street, N.W., Washington, DC, 20005, US

(73) Assignee: DaimlerChrysler AG.

(21) Appl. No.: 09/849,828

(22) Filed: May 7, 2001

Related U.S. Application Data
(63) Continuation of application No. 09/389,388, filed on Sep. 3, 1999, now abandoned.

(30) Foreign Application Priority Data
Sep. 3, 1998 (DE) 19840118.3-14
May 28, 1999 (DE) 199 24 494.4-14

(51) Int. Cl. B23K 26/38; B05D 3/12

(52) U.S. Cl. 219/121.69; 219/121.47; 427/357

(57) ABSTRACT

The present invention relates to a method for the surface working of a tribological coating of a supereutectic aluminum-silicon alloy or an aluminum-silicon composite material with a coating structure, wherein the surface is reworked after the production of the coating. Provision is made according to the invention that the surface is machined dry, without lubricant, in a one-step process, a cutting tool with a cutting material containing diamond being used. This can be followed by an additional working process. Preferably a combination process of dry machining and one-step finish honing or one-step texturing by radiation is provided.

The present invention relates to a method for the surface treatment of a tribological coating made of a supereutectic aluminum-silicon alloy and an aluminum-silicon laminate with a coating structure wherein the surface is reworked after the coating is produced.

Methods for the treatment of supereutectic aluminum-silicon alloys are known in themselves. These alloys serve especially for the production of workpieces with surfaces of wear-resistant, low-friction tribological coatings. Such workpieces and coatings are used, for example, in automobile manufacture to produce internal friction surfaces in crankcases and cylinder liners.

Present-day light construction crankcases for piston machines consist, for cost reasons, of subeutectic aluminum-silicon alloys which are made by pressure casting. This material, however, does not provide satisfactory friction and wear qualities. Cylinder liners or at least their interior friction surfaces must therefore consist of a wear-resistant, low-friction, tribological material.

DE 44 38 550 A1 has disclosed a cylinder liner made from a supereutectic aluminum-silicon alloy which has fine silicon primary crystals and intermetallic phases in the form of hard particles. Such a material must then still be surface-treated: first a fine boring is performed, and then the surface is smoothed by honing. This takes place in series production in at least two working steps which are called “pre-honing” and “finish honing.” In a final step the silicon particles contained in the alloy, which form the actual friction surface, are exposed by etching the aluminum away with an aqueous solution of an acid.

EP 0 55 742 A1 has disclosed a honing process for refining workpiece surfaces in at least two steps. In one of the process steps the surface of the workpiece is finish-honed to the final dimension. Thus a very finely honed texture is produced in the surface. In another process step, which can be performed before or after the finish honing, striations intersecting one another are produced by a radiation apparatus, especially a laser. The final surface in this case has both honing striations and laser radiation traces.

Another possibility consists in coating the internal friction surfaces of the cylinder liners after the crankcase has been cast. This is accomplished, for example, by plasma spraying as described in DE 195 08 687 C2. By this method a layer of iron or steel alloy can be applied which is characterized by satisfactory friction and wear qualities.

German patent applications 197 33 204.8-45 and 197 33 205.6-45, which have an earlier priority but are not yet published, filed on Aug. 1, 1997, a hot-sprayed coating of a supereutectic aluminum-silicon alloy and aluminum-silicon composite is disclosed which is characterized by a heterogenic coating structure of a solid solution of aluminum, a coarse to very fine network of eutectic silicon, silicon segregations and particles, intermetallic phases and extremely finely divided oxides. This coating contains characteristic primary aluminum solid solution dendrites in which the dendrite arms are enveloped in eutectic silicon. The photomicrographs of such coatings show a characteristic sponge-like appearance. Silicon primary segregations and silicon particles are present only in a small percentage and have a small diameter. In the surface treatment of these coatings, the dendrite arms at the surface are lightly ground, so that in the exposure that follows the aluminum is etched away and the aluminum-free silicon structures remain, which form the actual friction surface.

The surface treatment of supereutectic aluminum-silicon coatings, regardless of their composition and structure, is nevertheless very complicated. Lubricants must be used which then in some cases must first be completely removed again before the hard particles are exposed.

The present invention is therefore addressed to the problem of devising a method of the kind referred to above which will be less complicated and less costly.

The solution is to finish the surface by machining it dry, without lubricant, in a one-step procedure, using a cutting tool with at least a diamond-containing cutting material.

The idea of the invention thus consists in replacing the conventional, complicated wet treatment such as honing, for example, with a dry finishing process in which a cutter with at least a diamond-containing cutting material is used. Surprisingly it was found that the quality of a surface treated by the method of the invention is comparable with the quality of a honed surface and may even be better.

Advantageous embodiments are to be seen in the subordinate claims. The cutting tool can be single-edged or multiple-edged. Suitable cutting tools are, for example, an indexable cutting tip or a cutter spindle equipped with a plurality of indexable cutting tips. Coated bores, such as cylinder liners with a friction surface coating, are preferably reworked by dry spindle cutting. The tool with one or more cutters, such as a cutting spindle equipped with one or more indexable cutting tips, is introduced into the standing, internally coated cylinder liner. The cutting is performed without coolant or under minimal lubrication conditions. Vice versa, it is of course also possible for the workpiece to be driven while a fixed tool is used.

Suitable cutting materials are, for example, polycrystalline diamond, monocrystalline diamond, or a carbide coated with a vapor-deposited diamond layer.

Hard components can be contained in the structure of the tribological coating. These are, as a rule, hard, primary and eutectic silicon particles. The hard coating components at the surface can be exposed immediately after the dry machining.

Another advantageous embodiment provides for the use of a combination of dry machining and an additional procedure wherein after the dry machining the surface is textured in a one-step process by irradiation, especially with radiation grooving. Preferably a laser texturizing of the surface is performed. This laser texturizing can advantageously be limited in the case of cylinder friction surfaces to the area of the top dead center, that is, the point at which the direction of the movement of the piston reverses and its velocity is zero. The laser texturization creates pockets in the surface in which lubricant can collect later on during operation. This solution is a combination process combining the dry cutting operation with a subsequent operation for texturing the surface by means of a beam. The final surface in this case has both a dry-cut striated texture produced with a specifically shaped cutter or cutters, on which beam grooving is superimposed.

The coating to be treated is preferably a coating produced by plasma spraying methods. A preferred aluminum-silicon alloy is substantially copper-free, i.e., it contains less than 1% copper by weight.

An embodiment of the present invention will now be described in connection with the appended photographs:

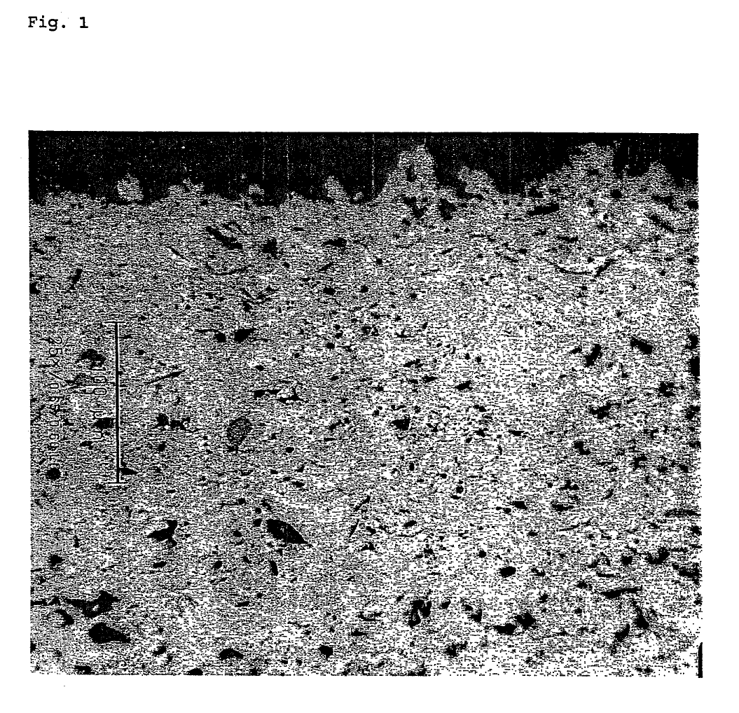

FIG. 1 is a photomicrograph of a coating applied by plasma spraying a substantially copper-free, supereutectic aluminum-silicon alloy before the surface treatment;

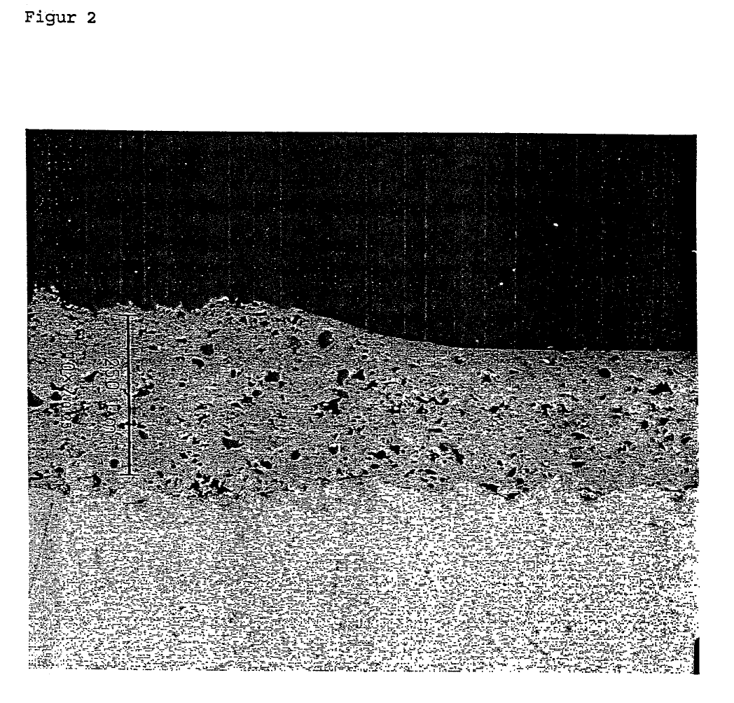

FIG. 2 shows the same coating after the dry machining with an indexable cutter tip of polycrystalline diamond (right) and an unmachined area (left);

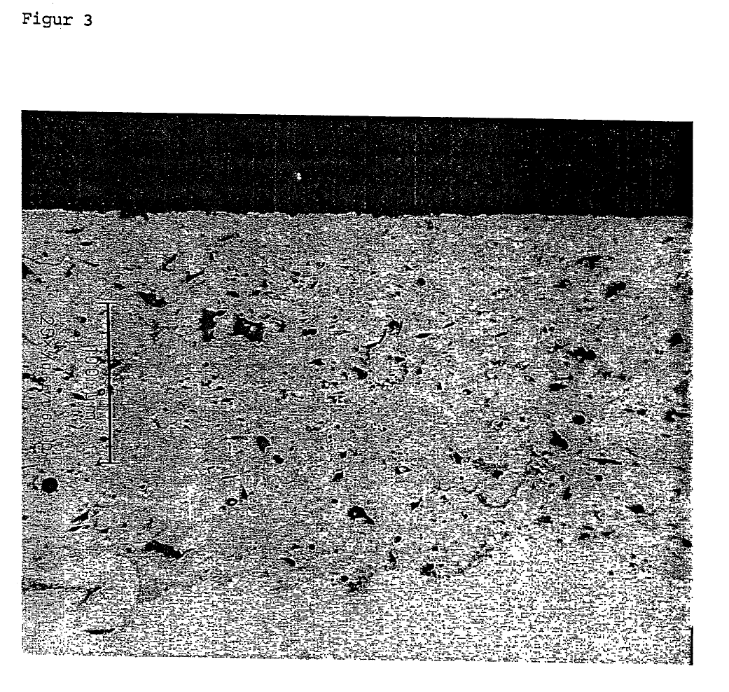

FIG. 3 shows the same coating as FIG. 2, but completely machined.

To prepare a coating of supereutectic aluminum-silicon alloy, any aluminum-silicon alloy can be used, such as AlSi25 Ni4 1.2 Fe 1.2 Mg, 0.6 Cu. The alloy may also contain solid lubricants such as hexagonal boron nitride, titanium dioxide, molybdenum sulfide and others.

Especially preferred are plasma-sprayed coatings of supereutectic aluminum-silicon alloys and supereutectic aluminum-silicon composite materials such as those described below.

Embodiment 1

A supereutectic aluminum-silicon alloy was used, having the following composition:

Alloy A:

Silicon: 23.0 to 40.0 wt.-%, preferably about 25 wt.-%

Magnesium: 0.8 to 2.0 wt.%-%, preferaabout about 1.2 wt.-%

Zirconium: maximum 0.6 wt.-%

Iron: maximum 0.25 wt.-%

Manganese, nickel, copper and zinc: maximum 0.01 wt.-% each

Balance: aluminum.

A spray powder was prepared from this alloy, and a coating thereof was applied by plasma spraying to the cylindrical friction surface of a cylinder liner made of subeutectic aluminum-silicon alloy. The cylinder liner has a diameter of 88 cm, a length of 150 mm and a wall thickness of 5 mm.

The coating before machining is represented in FIG. 1. The typical spongy structure is clearly to be seen. It is to be attributed to the formation of aluminum solid-solution dendrites whose arms are enveloped in a coating of eutectic silicon. Also seen are small primary silicon segregations.

The condition of the surface of the coating was characterized as follows:

Rₘₐₓ=21.5 μm; Rₜ=24.2 μm; R_{z}=17.7 μm; Rₐ=3.5 μm.

An indexable cutter tip with a cutting material of polycrystalline diamond of type TCMW 16 T3 08 F (CDIO) was chosen as the machining tool. The tool was of type Tizit NVR 16-3. For the dry fine turning the following parameters were established: feed=0.021 m/min; V_{c}=158.42 m/min; n=575 min⁻¹; aₚ=0.05.

FIG. 2 is a photomicrograph of the surface thus machined. The surface quality after being machined dry was able to be characterized as follows:

Rₘₐₓ=0.98 μm; Rₜ=0.99 μm; R_{z}=0.84 μm; Rₐ=0.125 μm.

These values are better than those achievable by conventional honing.

The following alloy can also be used, and can be reworked as described above, resulting in comparably good results:

Alloy B:

Silicon: 23.0 to 40.0 wt.-%, preferably about 25 wt.-%

Nickel: 1.0 to 5.0 wt.%-%, preferably about 4 wt.-%

Iron: 1.0 to 1.4 wt.%-%, preferably about 1.2 wt.-%

Magnesium: 0.8 to 2.0 wt.%-%, preferably about 1.2 wt.-%

Zirconium: maximum 0.6 wt.-%

Manganese, copper and zinc: maximum 0.01 wt.-% each Balance aluminum.

Composite materials produced by plasma spraying using a special spray powder can likewise be used. This spray powder is an agglomerated composite of fine silicon particles and fine metal particles of at least one aluminum-silicon alloy which are bonded together with the aid of inorganic or organic binders. The silicon particle content amounts to 5 to 95 wt.%-%, the content of alloy particles is 95 to 50 wt.-% The silicon particles have an average grain size of 0.1 to 10 μm, preferably about 5 μm.

The alloy particles have an average grain size of 0.1 to 50 μm, preferably about 5 μm.

The alloy particles consist preferably of a mixture of subeutectic alloy particles and supereutectic alloy particles. Through the use of supereutectic alloy particles the content of aluminum mixed crystal in the coating structure is maintained, while the formation of the aluminum mixed crystal is suppressed by the use of subeutectic alloy particles. Two examples of appropriate subeutectic and supereutectic alloys are given below.

Subeutectic alloys:

Alloy 1

Silicon: 0 to 11.8 wt.%-%, preferably about 9 wt.-%

Iron: maximum 0.25 wt.-%

Magnesium: 0.8 to 2.0 wt.%-%, preferably about 1.2 wt.-%

Zirconium: maximum 0.6 wt.-%

Manganese, nickel, copper and zinc: maximum 0.01 wt.-% each Balance aluminum.

Alloy 2

Silicon: 0 to 11.8 wt.%-%, preferably about 9 wt.-%

Nickel: 1.0 to 5.0 wt.%-%, preferably about 4 wt.-%

Iron: 1.0 to 1.4 wt.%-%, preferably about 1.2 wt.-%

Magnesium: 0.8 to 2.0 wt.%-%, preferably about 1.2 wt.-%

Zirconium: maximum 0.6 wt.-%

Manganese, copper and zinc: maximum 0.01 wt.-% each Balance aluminum.

Supereutectic alloys:

Alloy 3:

Silicon: 11.8 to 40.0 wt.-%, preferably about 17 wt.-%

Iron: maximum 0.25 wt.-%

Magnesium: 0.8 to 2.0 wt.-%, preferably about 1.2 wt.-%

Zirconium: maximum 0.6 wt.-%

Manganese, copper, nickel and zinc: maximum 0.01 wt.-% each Balance aluminum.

Alloy 4:

Silicon: 11.8 to 40.0 wt.-%, preferably about 17 wt.-%

Nickel: 1.0 to 5.0 wt.%-%, preferably about 4 wt.-%

Iron: 1.0 to 1.4 wt.%-%, preferably about 1.2 wt.-%

Magnesium: 0.8 to 2.0 wt.-%, preferably about 1.2 wt.-%

Zirconium: maximum 0.6 wt.-%

Manganese, copper and zinc: maximum 0.01 wt.-% each Balance aluminum

1. Method for the surface treatment of a tribological coating of a supereutectic aluminum-silicon alloy or an aluminum-silicon composite material with a coating structure, wherein the surface is reworked after the coating is produced, characterized in that the surface is machined dry in a one-step procedure, using a cutting tool with at least one diamond-containing cutting material.

2. Method according to claim 1, characterized in that a single-edge cutting tool, preferably an indexable insert, is used.

3. Method according to claim 1, characterized in that a multi-edged tool preferably a cutting spindle provided with a plurality of indexable inserts is used.

4. Method according to any one of the foregoing claims, characterized in that a cutting tool with a cutting material of polycrystalline diamond and/or monocrystalline diamond and/or carbide coated with a CVD diamond layer.

5. Method according to any one of the foregoing claims, characterized in that after the dry machining hard coating components contained in the coating structure and lying at the machined surface are immediately exposed.

6. Method according to any one of the foregoing claims, characterized in that a combination of dry machining and an additional process is used, wherein after the dry machining the surface is finish-honed in a one-step process.

7. Method according to any one of claims 1 to 5, characterized in that a combination of the dry machining and an additional method is used, wherein after the dry machining the surface is textured in a one-step process by irradiation, by laser for example, especially with radiation grooving.

8. Method according to any one of the foregoing claims, characterized in that a cylinder friction surface of a crankcase for a piston machine, coated with the supereutectic aluminum-silicon alloy or the supereutectic aluminum-silicon material, is reworked.

9. Method according to any one of the foregoing claims, characterized in that the cylinder friction surface is reworked only in the area of the top dead center and that the hard coating components lying in the cylinder friction surface are exposed only in the area of the top dead center.

10. Method according to any one of the foregoing claims, characterized in that the coating to be worked is produced by plasma spraying methods.

11. Method according to any one of the foregoing claims, characterized in that the coating to be worked is produced from a substantially copper-free supereutectic aluminum-silicon alloy or a substantially copper-free supereutectic aluminum-silicon composite material, the copper content being less than 1 wt.-%, preferably smaller than 0.1 wt.-% and especially less than 0.01 wt.-%.

12. Method according to any one of the foregoing claims, characterized in that to produce the coating to be worked an alloy is used which has a heterogenic coating structure of a primary aluminum solid solution, a coarse to very fine network of eutectic silicon, primary silicon segregations as well as intermetallic phases such as Mg₂Si and oxides, the average size of the primary silicon segregations being less than 10 μm and the average size of the oxides being smaller than 5 μm.

13. Method according to any one of the foregoing claims, characterized in that to produce the coating to be worked a composite material is used which has a heterogenic coating structure of a primary aluminum solid solution, a coarse to very fine network of eutectic silicon, primary silicon segregations and/or embedded silicon particles and intermetallic phases such as Mg₂Si and oxides, the average size of the primary silicon segregations being less than 10 μm and the average size of the oxides being smaller than 5 μm.
